(19) United States
(12) Patent Application Publication
(10) Pub. No.: US 2021/0157333 A1
(43) Pub. Date: May 27, 2021

(54) AUTOMATIC DRIVING CONTROL SYSTEM, SERVER DEVICE, AND RECORDING MEDIUM

(71) Applicant: Toyota Jidosha Kabushiki Kaisha, Toyota-shi Aichi-ken (JP)

(72) Inventor: Akira Sasaki, Miyoshi-shi (JP)

(21) Appl. No.: 17/101,328

(22) Filed: Nov. 23, 2020

(30) Foreign Application Priority Data
Nov. 25, 2019 (JP) 2019-212047

(51) Int. Cl. G05D 1/02

(52) U.S. Cl. CPC G05D 1/0276; G05D 1/0231

(57) ABSTRACT

An automatic driving control system includes: an automatic driving vehicle; and a server device connected to the automatic driving vehicle via a telecommunication line. Further, the server device includes a database storing information about vehicle driving characteristics of each of areas, and a control unit that, in a case where it is determined, based on position information of the automatic driving vehicle acquired via the telecommunication line, that the automatic driving vehicle is located within an area stored in the database, controls an operation of the automatic driving vehicle, based on the information about the vehicle driving characteristics of the area stored in the database.

### CROSS-REFERENCE TO RELATED APPLICATION(S)

The present application claims priority to and incorporates by reference the entire contents of Japanese Patent Application No. 2019-212047 filed in Japan on Nov. 25, 2019.

### BACKGROUND

The present disclosure relates to an automatic driving control system, a server device, and a recording medium.

Japanese Laid-open Patent Publication No. 2019-119269 describes an automatic driving control system that controls automatic driving in accordance with a driving environment of a vehicle.

In each of areas, there may be vehicle driving characteristics (driving tendency, driving manners) peculiar to the area, such as Nagoya running, i.e., driving manners seen in Nagoya city (and in the vicinity of it) in Aichi prefecture in Japan and no need to stop before a railroad crossing (in USA). Therefore, when the operation of an automatic driving vehicle is controlled without considering the vehicle driving characteristics in the area, occupant(s) in the automatic driving vehicle may feel confused or uneasy.

### SUMMARY

There is a need for providing an automatic driving control system, a server device, and a recording medium (program) that are able to control automatic driving of a vehicle in consideration of vehicle driving characteristics peculiar to an area.

According to an embodiment, an automatic driving control system includes: an automatic driving vehicle; and

a server device connected to the automatic driving vehicle via a telecommunication line. Further, the server device includes a database storing information about vehicle driving characteristics of each of areas, and a control unit that, in a case where it is determined, based on position information of the automatic driving vehicle acquired via the telecommunication line, that the automatic driving vehicle is located within an area stored in the database, controls an operation of the automatic driving vehicle, based on the information about the vehicle driving characteristics of the area stored in the database.

According to an embodiment, a server device includes a processor having hardware. Further, in a case where it is determined, based on position information of an automatic driving vehicle acquired via a telecommunication line, that the automatic driving vehicle is located within an area stored in a database, the processor controls an operation of the automatic driving vehicle, based on information about vehicle driving characteristics of the area stored in the database.

According to an embodiment, a non-transitory computer readable recording medium stores a program for causing a processor having hardware to control, in a case where it is determined, based on position information of an automatic driving vehicle acquired via a telecommunication line, that the automatic driving vehicle is located within an area stored in a database, an operation of the automatic driving vehicle, based on information about vehicle driving characteristics in the area stored in the database.

### BRIEF DESCRIPTION OF THE DRAWINGS

FIG. 1 is a block diagram illustrating a configuration of an automatic driving control system according to an embodiment of the present disclosure;

FIG. 2 is a diagram illustrating an example of vehicle control rule data stored in the vehicle control rule database illustrated in FIG. 1; and

FIG. 3 is a timing chart illustrating a flow of automatic driving control processing that is an embodiment of the present disclosure.

### DETAILED DESCRIPTION

Referring to the drawings, an automatic driving control system according to an embodiment of the present disclosure will be described in detail below.

Configuration

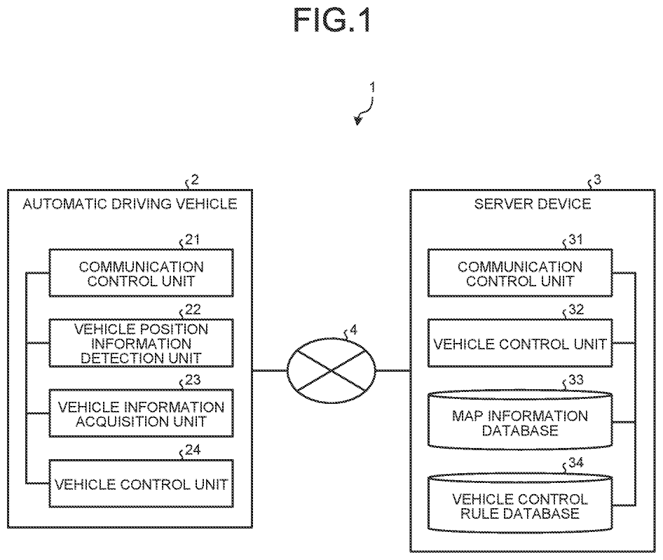

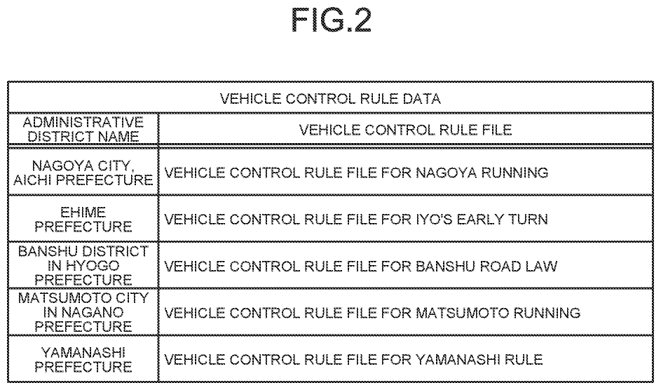

First, the configuration of an automatic driving control system according to an embodiment of the present disclosure will be described with reference to FIGS. 1 and 2.

FIG. 1 is a block diagram illustrating a configuration of an automatic driving control system according to an embodiment of the present disclosure. FIG. 2 is a diagram illustrating an example of vehicle control rule data stored in a vehicle control rule database 34 illustrated in FIG. 1.

As illustrated in FIG. 1, an automatic driving control system 1 according to an embodiment of the present disclosure includes an automatic driving vehicle 2 and a server device 3 as main components, and the automatic driving vehicle 2 and the server device 3 are configured to be able to mutually communicate information via a telecommunication line 4 such as an internet line network or a mobile phone line network.

The automatic driving vehicle 2 includes a communication control unit 21, a vehicle position information detection unit 22, a vehicle information acquisition unit 23, and a vehicle control unit 24.

The communication control unit 21 is a device that controls information communication with the server device 3 via the telecommunication line 4. Specifically, the communication control unit 21 receives a variety of information transmitted from the server device 3 via the telecommunication line 4 and transmits a variety of information to the server device 3 via the telecommunication line 4. As the communication control unit 21, a communication unit for data communication module (DCM) or a communication unit that communicates information by using a mobile radio communication network can be adopted.

The vehicle position information detection unit 22 is a device that detects position information of the automatic driving vehicle 2 by receiving radio waves from a global positioning system (GPS) satellite. As a method for detecting the position information of the automatic driving vehicle 2, a method combining light detection and ranging, or laser imaging detection and ranging (LiDAR) and a three-dimensional digital map can be adopted.

The vehicle information acquisition unit 23 is a device that acquires various kinds of information (vehicle information) about a state of the automatic driving vehicle 2. The information about the state of the automatic driving vehicle 2 acquired by the vehicle information acquisition unit 23 includes an operating state of a blinker, an operating state of a braking device, an operating state of a steering device, an operating state of an accelerator pedal, a traveling speed of the automatic driving vehicle 2, etc.

The vehicle control unit 24 includes a processor having hardware such as a central processing unit (CPU), a digital signal processor (DSP), or a field-programmable gate array (FPGA) and a storage unit such as a random access memory (RAM) or a read only memory (ROM). The vehicle control unit 24 downloads a computer program, stored in the storage unit, to a work area of the storage unit and executes the computer program, thereby controlling each of units of the automatic driving vehicle 2 in accordance with a control signal from the server device 3.

The server device 3 is configured by an information processing device capable of executing various information processes by using cloud computing technology or edge computing technology and includes a communication control unit 31, a vehicle control unit 32, a map information database 33, and a vehicle control rule database 34.

The communication control unit 31 is a device that controls information communication with the automatic driving vehicle 2 via the telecommunication line 4. Specifically, the communication control unit 31 receives a variety of information transmitted from the automatic driving vehicle 2 via the telecommunication line 4 and transmits a variety of information to the automatic driving vehicle 2 via the telecommunication line 4. As the communication control unit 31, a communication unit for DCM or a communication unit for communicating information by using a mobile radio communication network can be adopted.

The vehicle control unit 32 includes a processor having hardware such as a CPU, a DSP, or an FPGA, and a storage unit such as a RAM or a ROM. The vehicle control unit 32 downloads a computer program, stored in the storage unit, to a work area of the storage unit and executes the computer program, thereby controlling an operation of the automatic driving vehicle 2.

The map information database 33 stores map information. Here, the map information is information necessary to specify the positions of a road, a road structure, facilities, etc., examples of which include, data about each node set on a road (e.g., a node ID, coordinates, etc.), data about each link set on a road (e.g., a link ID, a link name, a connection node ID, road coordinates, a road type (such as a toll road, a general road or the like), the number of lanes), and feature data (e.g., a traffic light, a road sign, a guardrail, facilities, etc.).

The vehicle control rule database 34 stores information (vehicle control rule data) about control rules for the automatic driving vehicle 2 in each administrative district. Specifically, as illustrated in FIG. 2, in the vehicle control rule database 34, an electronic file indicating control rules for the automatic driving vehicle 2 in a corresponding administrative district is stored as vehicle control rule data for each administrative district. Here, control rules for the automatic driving vehicle 2 in each administrative district are set in consideration of the information about the respective vehicle driving characteristics of the administrative district. For example, the vicinity of Nagoya city in Aichi Prefecture in Japan is known as its vehicle driving characteristics called “Nagoya running (for example, a driver may not operate a blinker when changing a lane, a vehicle waiting for turning to the right passes the head of a line of vehicles waiting for turning to the right, and such). Therefore, control rules for the automatic driving vehicle 2 appropriate for an operating state of the automatic driving vehicle 2 and a lane in which this vehicle is traveling are set in consideration of vehicle driving characteristics, such as making an inter-vehicle distance longer than usual when the automatic driving vehicle 2 makes a right turn in the vicinity of Nagoya city. As for other vehicle driving characteristics in administrative districts, “Iyo's early turn” in Ehime prefecture, “Banshu road law” in Banshu district in Hyogo prefecture, “Matsumoto running” in Matsumoto city in Nagano prefecture, “Yamanashi rule” in Yamanashi prefecture, etc. are also known.

The driving characteristic data for each administrative district can be created by extracting vehicle driving characteristics peculiar to each administrative district by analyzing, by means of artificial intelligence or the like, vehicle position information and behavior information (a vehicle speed, an inter-vehicle distance, an operation timing of a blinker, etc.) acquired by, for example, a drive recorder (an imaging device), a probe car, or road-to-vehicle communication. In the present embodiment, vehicle driving characteristics are stored for each administrative district as a unit; however, the unit for storing vehicle driving characteristics is not limited to an administrative district, and vehicle driving characteristics can be stored for any area (region).

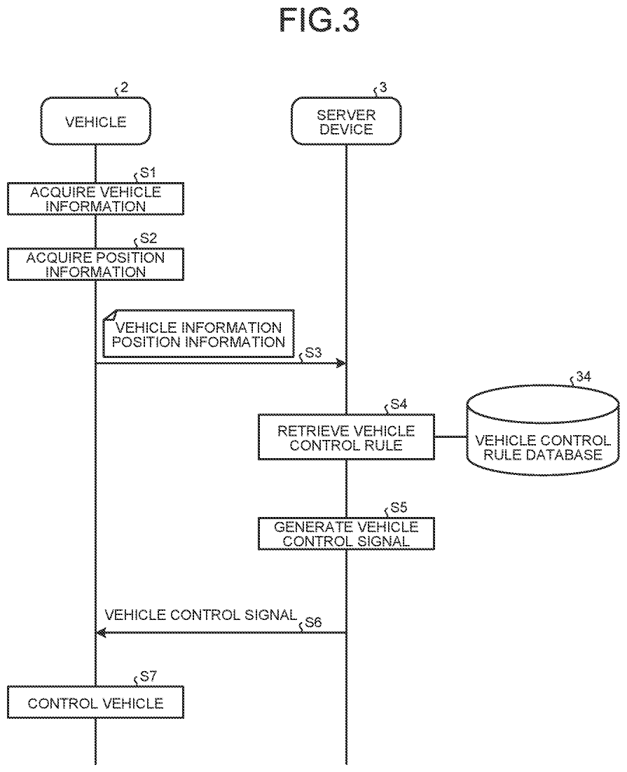

In the automatic driving control system 1 having such a configuration, the server device 3 controls an operation of the automatic driving vehicle 2 in consideration of vehicle driving characteristics peculiar to an area, by executing the following automatic driving control processing. An operation of the server device 3 when executing the automatic driving control processing will now be described with reference to FIG. 3.

Automatic Driving Control Processing

FIG. 3 is a timing chart illustrating a flow of the automatic driving control processing that is an embodiment of the present disclosure. The timing chart illustrated in FIG. 3 starts at the timing of the switching on of the ignition switch of the automatic driving vehicle 2 from an off-state, and the automatic driving control processing proceeds to the process of step S1. This automatic driving control processing is repeatedly executed every predetermined control period while the ignition switch of the automatic driving vehicle 2 is in an on-state.

In the process of step S1, the vehicle control unit 24 of the automatic driving vehicle 2 acquires the vehicle information of the automatic driving vehicle 2 by controlling the vehicle information acquisition unit 23. As a result, the process of step S1 is completed, and the automatic driving control processing proceeds to the process of step S2.

In the process of step S2, the vehicle control unit 24 of the automatic driving vehicle 2 acquires the position information of the automatic driving vehicle 2 by controlling the vehicle position information detection unit 22. As a result, the process of step S2 is completed and the automatic driving control processing proceeds to step S3.

In the process of step S3, the vehicle control unit 24 of the automatic driving vehicle 2 controls the communication control unit 21, thereby transmitting the vehicle information of the automatic driving vehicle 2 acquired in the process of step S1 and the position information of the automatic driving vehicle 2 acquired in the process of step S2, to the server device 3 via the telecommunication line 4. As a result, the process of step S3 is completed, and the automatic driving control processing proceeds to the process of step S4.

In the process of step S4, the communication control unit 31 of the server device 3 receives the vehicle information and the position information of the automatic driving vehicle 2 transmitted from the automatic driving vehicle 2 via the telecommunication line 4. Then, based on the received position information of the automatic driving vehicle 2, the vehicle control unit 32 of the server device 3 retrieves, from the vehicle control rule database 34, the vehicle control rule data of the administrative district in which the automatic driving vehicle 2 is located. As a result, the process of step S4 is completed, and the automatic driving control processing proceeds to step S5.

In the process of step S5, based on the vehicle information and the position information of the automatic driving vehicle 2 received in the process of step S2 and the vehicle control rule data retrieved in the process of step S3, the vehicle control unit 32 of the server device 3 generates a vehicle control signal for controlling an operation of the automatic driving vehicle 2. If the vehicle control rule data is not retrieved in the process of step S3, the vehicle control unit 32 generates a vehicle control signal, based on the vehicle information and the position information of the automatic driving vehicle 2 received in the process of step S2. As a result, the process of step S5 is completed, and the automatic driving control processing proceeds to the process of step S6.

In the process of step S6, the vehicle control unit 32 of the server device 3 controls the communication control unit 31, thereby transmitting the vehicle control signal generated in the process of step S5 to the automatic driving vehicle 2 via the telecommunication line 4. As a result, the process of step S6 is completed, and the automatic driving control processing proceeds to the process of step S7.

In the process of step S7, the communication control unit 21 of the automatic driving vehicle 2 receives the vehicle control signal transmitted from the server device 3 via the telecommunication line 4. Then, the vehicle control unit 24 of the automatic driving vehicle 2 controls each unit of the automatic driving vehicle 2 according to the vehicle control signal, thereby controlling the operation of the automatic driving vehicle 2. As a result, the process of step S7 is completed, and the automatic driving process returns to the process of step S1.

As is clear from the above description, in the automatic driving control system 1 according to the embodiment of the present disclosure, in a case where it is determined, based on the position information of the automatic driving vehicle 2 acquired via the telecommunication line 4, that the automatic driving vehicle 2 is located within an administrative district stored in the vehicle control rule database 34, the server device 3 controls an operation of the automatic driving vehicle 2, based on the information about the vehicle driving characteristics stored in the vehicle control rule database 34. Accordingly, the automatic driving vehicle 2 can be controlled in consideration of the vehicle driving characteristics peculiar to the area.

According to the present disclosure, automatic driving of a vehicle can be controlled in consideration of vehicle driving characteristics peculiar to an area.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic driving control system comprising:
an automatic driving vehicle; and
a server device connected to the automatic driving vehicle via a telecommunication line,
wherein the server device includes
a database storing information about vehicle driving characteristics of each of areas, and
a control unit that, in a case where it is determined, based on position information of the automatic driving vehicle acquired via the telecommunication line, that the automatic driving vehicle is located within an area stored in the database, controls an operation of the automatic driving vehicle, based on the information about the vehicle driving characteristics of the area stored in the database.

2. The automatic driving control system according to claim 1,
wherein the database stores information about vehicle automatic driving control rules in each area, the information being set based on the information about vehicle driving characteristics of each area, and
the control unit controls the operation of the automatic driving vehicle according to the vehicle automatic driving control rules in the area where the automatic driving vehicle is located.

3. The automatic driving control system according to claim 2,
wherein the automatic driving control rules include an automatic driving control rule appropriate for a vehicle operating state, and
based on information about an operating state of the automatic driving vehicle acquired via the telecommunication line, the control unit controls the operation of the automatic driving vehicle according to an automatic driving control rule corresponding to the operating state of the automatic driving vehicle.

4. The automatic driving control system according to claim 2,
wherein the automatic driving control rules include an automatic driving control rule appropriate for a lane in which the automatic driving vehicle is traveling, and
based on information about a lane in which the automatic driving vehicle is traveling acquired via the telecommunication line, the control unit controls the operation of the automatic driving vehicle according to an automatic driving control rule corresponding to the lane in which the automatic driving vehicle is traveling.

5. The automatic driving control system according to claim 1, wherein the information about the vehicle driving characteristics of each of the areas is created by analyzing vehicle information of each area acquired via the telecommunication line.

6. The automatic driving control system according to claim 5, wherein the vehicle information includes vehicle information captured by an imaging device mounted in the vehicle.

7. The automatic driving control system according to claim 5, wherein the vehicle information includes vehicle information acquired by road-to-vehicle communication.

8. A server device comprising
a processor having hardware,
wherein, in a case where it is determined, based on position information of an automatic driving vehicle acquired via a telecommunication line, that the automatic driving vehicle is located within an area stored in a database, the processor controls an operation of the automatic driving vehicle, based on information about vehicle driving characteristics of the area stored in the database.

9. The server device according to claim 8,
wherein the database stores information about vehicle automatic driving control rules in each area, the information being set based on the information about vehicle driving characteristics of each area, and
the processor controls the operation of the automatic driving vehicle according to the vehicle automatic driving control rules in the area where the automatic driving vehicle is located.

10. The server device according to claim 9,
wherein the automatic driving control rules include an automatic driving control rule appropriate for a vehicle operating state, and
based on information about an operating state of the automatic driving vehicle acquired via the telecommunication line, the processor controls the operation of the automatic driving vehicle according to an automatic driving control rule corresponding to the operating state of the automatic driving vehicle.

11. The server device according to claim 9,
wherein the automatic driving control rules include an automatic driving control rule appropriate for a lane in which the vehicle is traveling, and
based on information about a lane in which the automatic driving vehicle is traveling acquired via the telecommunication line, the processor controls the operation of the automatic driving vehicle according to an automatic driving control rule corresponding to the lane in which the automatic driving vehicle is traveling.

12. The server device according to claim 8, wherein the information about the vehicle driving characteristics of each of the areas is created by analyzing vehicle information of each area acquired via the telecommunication line.

13. The server device according to claim 12, wherein the vehicle information includes vehicle information captured by an imaging device mounted in the vehicle.

14. The server device according to claim 12, wherein the vehicle information includes vehicle information acquired by road-to-vehicle communication.

15. A non-transitory computer readable recording medium storing a program for causing a processor having hardware to control, in a case where it is determined, based on position information of an automatic driving vehicle acquired via a telecommunication line, that the automatic driving vehicle is located within an area stored in a database, an operation of the automatic driving vehicle, based on information about vehicle driving characteristics in the area stored in the database.

16. The recording medium storing the program according to claim 15, the program causing the processor to control the operation of the automatic driving vehicle according to vehicle automatic driving control rules in each area, the vehicle automatic driving control rules being set based on information about vehicle driving characteristics of each area.

17. The recording medium storing the program according to claim 16,
wherein the automatic driving control rules include an automatic driving control rule appropriate for a vehicle operating state, and
based on information about an operating state of the automatic driving vehicle acquired via the telecommunication line, the processor is caused to control the operation of the automatic driving vehicle according to an automatic driving control rule corresponding to the operating state of the automatic driving vehicle.

18. The recording medium storing the program according to claim 16,
wherein the automatic driving control rules include an automatic driving control rule appropriate for a lane in which the vehicle is traveling, and
based on information about a lane in which the automatic driving vehicle is traveling acquired via the telecommunication line, the processor is caused to control the operation of the automatic driving vehicle according to an automatic driving control rule corresponding to the lane in which the automatic driving vehicle is traveling.

19. The recording medium storing the program according to claim 15, wherein the information about the vehicle driving characteristics of each of the areas is created by analyzing vehicle information of each area acquired via the telecommunication line.

20. The recording medium storing the program according to claim 19, wherein the vehicle information includes vehicle information captured by an imaging device mounted in the vehicle.
